(19) United States
(12) Patent Application Publication
(10) Pub. No.: US 2009/0218552 A1
(43) Pub. Date: Sep. 3, 2009

(54) Method of Producing Portland Cement Having Electrical Conduction and Optical Properties

(75) Inventors: Sergio Omar Galván Cázares, Maxico City (MX); Joel Sosa Gutiérrez, Mexico City (MX)

Correspondence Address: JOHN F. LETCHFORD, ARCHER & GREINER, P.C., ONE CENENNIAL SQUARE, HADDONFIELD, NJ, 08033, US

(73) Assignee: CONRETOS TRANSLÚCIDOS, S. de R.L. de C.V., Col. Guadalupe Inn (MX)

(21) Appl. No.: 12/084,746

(22) PCT Filed: Nov. 10, 2006
(86) PCT No.: PCT/MX2006/000124

§ 371 Date: Apr. 16, 2009

(30) Foreign Application Priority Data
Nov. 11, 2005 (MX) PA/A/2005/012185
Nov. 11, 2005 (MX) PA/A/2005/012186

(51) Int. Cl. C04B 7/04; H01B 1/06

(52) U.S. Cl. 252/519.4

(57) ABSTRACT

A method of producing conductive and/or translucent Portland cement which has high sulphate resistance and a service life of up to 70 years under normal service conditions. Once cement has set, light can pass therethrough. Up to 70% of the final resistance of the cement is reached within 48 hours of setting. The inventive production method is characterised in that it produces a fineness of more than 3450 cm2/g and in that, upon setting, the concrete has a mechanical strength of between 26 MPa and 250 MPa, without the addition of additives, thereby enabling a reduction in the water required to obtain a determined slump.

### TECHNICAL FIELD OF THE INVENTION

This invention relates to a cement that relates to a cement with optical and electrical properties that significantly set it apart from those currently existing ion the state of the art, together with its manufacturing method.

### PRIOR ART OF THE INVENTION

Portland cement corresponds to a specific type of cement the strength properties of which are due to its composition and manufacturing process or method. Thus, the method and composition for Portland cement is as follows:

Clay and limestone materials are crushed, mixed and ground down to a fine powder. The composition of this mixture must remain constant within narrow limits because any distancing from the optimum point would result in a loss of quality. The mixing and grindings can be performed dry (dry method) or with water (wet method). In any case, whatever the preparation method, it is essential for the mixture to have the correct dosage, which is finally ground down and thoroughly mixed before entering the kiln.

The mixture is then taken to a rotary kiln in which it is slowly heated to the point of clinkerisation. The water and carbon dioxide are expulsed prior to reaching this point. On approaching the hottest temperatures, chemical reactions take place between the raw mixture components. New compounds are formed during these reactions, with some of them melting, leaving the load partially melted. The clinker then falls onto one of the various coolers or onto the pile of clinker where it cools, sometimes by means of a water spray. When cool, it is maxed with a carefully calculated amount of fired or raw gypsum and ground down until it is a fine powder, which is now commercial Portland cement.

The gypsum or calcium sulphate is added in small amounts to the final grinding operation to control the setting temperature and prevent false setting. However, if the amount of gypsum is not correctly monitored, a small variation in the established proportions if the crushed rock mixture could be sufficient to completely alter the characteristics of the mixture or the cement properties.

Cement obtained in this way has characteristics similar to rock when it hardens and behaves like a high-density dielectric solid that does not allow light to pass through it and has high volumetric weight and mechanical behaviour similar to rock.

For the purpose of suppressing these and other disadvantages, a Portland cement manufacturing method was developed that permits the manufacture of a type of concrete, which when set allows light to pass through, in other words is translucent and/or improve its electrical properties to convert it into an electrical conductor, together with enhancing the mechanical characteristics of said concrete through suitable additions to the grinding process and which are the object of this invention.

### OBJECT OF THE INVENTION

The purpose of this invention is to disclose a composition and method for the manufacture of Portland cement, the new characteristics of which are those of allowing light to pass through it, in other words, being translucent.

A second purpose is to describe a composition and manufacturing method for Portland cement possessing improved electrical conduction properties compared to already known cements.

Finally, a third purpose of this invention is to provide a composition and manufacturing method for Portland cement having translucent and/or small electrical current conduction properties, in addition to high mechanical strength and long useful life.

### DESCRIPTION OF THE INVENTION

In general, all types of materials are used to make Portland cement, which provide the required chemical composition when calcined. However, taking economy into account, the number of such materials is limited.

Suitable limestone materials are: gypsum cement rock, chalk, marl, seashells and waste from alkali production.

Some components have been found to be harmful in cement and this still further limits the gypsums and marls etc, which are suitable.

Gypsum and other calcareous substances rich in magnesium carbonate are unsuitable because an amount exceeding 5% is considered harmful in Portland cement and is not permitted in normal specifications. Veins of chalk or pyrites may mean that the sulphate content is excessive. Chalk sometimes contains nodules of flintstone that must be removed and marl could contain excessive amounts of siliceous sand.

Pure gypsum is hard and requires a lot of energy during grinding. However, if it is found mixed with slate, it is softer. Cement rock, which is found in great abundance in the Lehigh Valley, is a gypsum containing such an amount of clay material that it is not necessary any more or to use a mixture made with rich rocks and poor in lime.

Marl is a sedimentary calcareous material that forms at the bottom of certain lakes and is often missed with a large amount of small shells. Significant formations of marl and seashells are exploited in Michigan, USA and in Norfolk, Va., also in USA. In Texas and Redwood Calif., USA there are cement works that successfully work with limestone materials form old oyster beds. Chalk is employed in Louisiana, USA and to a large extent in the UK and the rest of Europe.

In Michigan USA, the precipitated calcium carbonate obtained a waste product from the manufacture of caustic soda in the Le Blanc process, has been employed in Portland cement production.

The following materials can be used to make Portland cement: clay, slate, schist, blast furnace slag, ash and cement rock.

The first step in mixing materials should take place in the quarry using steam shovels, with one shovelful of clay and two of stone, or two wagonloads of one rock and three of the other. The rock is then passed through a battery of crushing mills and be converted into gravel.

The mixture is then taken to a rotary kiln in which it is slowly heated to 1,450 degrees centigrade until the clinkerisation point. The water and carbon dioxide are expulsed prior to reaching this point. On approaching the highest temperatures, chemical reactions take place between the raw mixture components. New compounds are formed during these reactions, with some of them melting, leaving the load partially melted.

The clinker then falls onto one of the various coolers or onto the pile of clinker where it cools.

If the mixture is prepared as indicated, then through constant monitoring of its lime content, various modifications can be made to the clay or gypsum amounts when they are added to the grinders, if these modifications are necessary to maintain an approximate constant composition. However, if it is seen that the crushed rock in the tanks has higher or lower lime content, the content of two or more tanks is mixed so that mixture proportions are as close as possible to the suitable composition.

Clinker cooling can be produced by a closed cooler using air circulation, in which the clinker cooling air is employed as secondary or even primary kiln combustion. This allows economy in furl as well as better clinker calcination, immediate use of clinker in grinding and enhanced grinding, together with better strength values and volume stability in the cement.

When the clinker is taken to the mills, it is mixed with a carefully calculated amount of retardant consisting of plaster stone (CaSO₄.2H₂O) or baked plaster (CaSO₄.½H₂O) because, without this, when the cement is mixed with water to form concrete, it could set too quickly. The amount of plaster stone or baked plaster is limited by the alumina content of the mixture. The mixture of clinker and plaster stone or baked plaster is ground down with a surface area that is specified for each type of cement because the cement will develop its strength much quicker the more finely it is ground down.

It is in this stage of the process when glass powder and epoxy resins and/or breeze-type carbon are added to the clinker, provided the magnesia content of the composition is no greater than 5%. The grain size of this dust must be less than one millimetre in diameter. The amount of glass dust employed should be 5% of the total weight of plaster stone and baked plaster.

The content of pieces of epoxy resin must be carefully controlled and monitored throughout the grinding process and should be added when the clinker has already been cooled and does not have a temperature exceeding 75 degrees centigrade. The resin content should lie between 30% and 54% of the clinker weight, with 46% being the optimum value.

In the resin grain size used in this grinding should be at least 55% with a diameter greater than 20 millimetres and a maximum of 45% with a diameter less than 15 millimetres.

It is also important for the materials (resins and clinker) to be finely ground down and uniformly mixed, because if they are not the reactions will not be uniform throughout the mass. One area of resin particles may be dragged so far away from another with acid components that they remain in free resin form.

During the grinding operation, the temperature in the mill should not exceed 75 degrees centigrade in order to prevent any reactions between the resins and clinker components.

The breeze-type coke must be carefully controlled and monitored throughout the grinding process and should be added when the clinker has already been cooled and does not have a temperature exceeding 55 degrees centigrade. The carbon content should be between 37% and 49% the weight of the clinker, with the optimum being 42.7%.

The grain size for the coke use in this grinding operation should have at least 45% coke with a diameter exceeding 12 millimetres and 55% of the coke with a diameter of less than 7 millimetres. It is also important for the materials (resins and clinker) to be finely ground down and uniformly mixed, because if they are not the reactions will not be uniform throughout the mass. One area of coke particles may be dragged so far away from another with acid components that they remain in free coke form.

The grinding process must ensure a fineness of between 3,450 and 3,850 cm²/g, which should be monitored by the amount of material passing through a number 100 or 200 sieve (free mesh span of 0.147 and 0.074 millimetres respectively). In the case of the cement not having the mentioned fineness, then a new grinding stage must be initiated until the established value is obtained.

Once ground down and while still warm from the grinding process, it should be stored in silos for at least three days, but no more than six, so that all the small quantities of lime that did not combine during the calcination process can hydrate and carbonate through reactions with water and carbon dioxide in the air and thus lose the expansion resulting from these particles remaining without combining with the lime.

Having described the invention, we consider it as being new and therefore reclaim the content of the following claims as our own:

1. A method of manufacturing Portland cement with optical and electrical conduction properties that consists of the following stages:
mixing raw materials in the quarry using steam shovels, with one shovelful of clay and two of stone, or two wagonloads of the cement rock and three of the other, the rock is then passed through a battery of crushing mills and be converted into gravel;
the mixture is then taken to a rotary kiln in which it is slowly heated to 1,450 degrees centigrade up to the clinkerisation point;
taking the clinker to one of various coolers;
adding the amounts of clay or gypsum;
tipping the mixture in to mills;
cooling the clinker in a closed cooler with air circulation;
taking the clinker to the mills and carefully mix with a carefully weighed amount of retardant, such as plaster stone (CaSO₄.2H₂O) or baked plaster (CaSO₄.½H₂O);
the mixture of clinker and plaster stone or baked plaster is ground down with a surface area that is specified for each type of cement because the cement will develop its strength much quicker the more finely it is ground down;
glass powder and epoxy resins and/or breeze-type carbon are added to the clinker, together with the plaster stone and baked plaster;
continue grinding to obtain a fineness of between 3,450 and 3,850 cm²/g, which should be monitored by the percentage of material passing through a number 100 or 200 sieve (free mesh span of 0.147 and 0.074 millimetres respectively);
it should be stored in silos for at least three days, but no more than six.

2. A method of manufacturing Portland cement with optical and electrical conduction properties that consists of the following stages:
mixing raw materials in the quarry using steam shovels, with one shovelful of clay and two of stone, or two wagonloads of the cement rock and three of the other, the rock is then passed through a battery of crushing mills and be converted into gravel;
the mixture is then taken to a rotary kiln in which it is slowly heated to 1,450 degrees centigrade up to the clinkerisation point;
taking the clinker to one of various coolers;
adding the amounts of clay or gypsum;
tipping the mixture in to mills;
cooling the clinker in a closed cooler with air circulation;
taking the clinker to the mills and carefully mix with a carefully weighed amount of retardant, such as plaster stone (CaSO₄.2H₂O) or baked plaster (CaSO₄.½H₂O);
the mixture of clinker and plaster stone or baked plaster is ground down with a surface area that is specified for each type of cement because the cement will develop its strength much quicker the more finely it is ground down;
glass powder and epoxy resins and/or breeze-type carbon are added to the clinker, together with the plaster stone and baked plaster;
continue grinding to obtain a fineness greater than 3,450 cm²/g, which should be monitored by the percentage of material passing through a number 100 or 200 sieve (free mesh span of 0.147 and 0.074 millimetres respectively);
it should be stored in silos for at least three days, but no more than six.

3. A method of manufacturing Portland cement with optical and electrical conduction properties that consists of the following stages:
mixing raw materials in the quarry using steam shovels, with one shovelful of clay and two of stone, or two wagonloads of the cement rock and three of the other, the rock is then passed through a battery of crushing mills and be converted into gravel;
the mixture is then taken to a rotary kiln in which it is slowly heated to 1,450 degrees centigrade up to the clinkerisation point;
taking the clinker to one of various coolers;
adding the amounts of clay or gypsum;
tipping the mixture in to mills;
cooling the clinker in a closed cooler with air circulation;
taking the clinker to the mills and carefully mix with a carefully weighed amount of retardant, such as plaster stone (CaSO₄.2H₂O) or baked plaster (CaSO₄.½H₂O);
the mixture of clinker and plaster stone or baked plaster is ground down with a surface area that is specified for each type of cement because the cement will develop its strength much quicker the more finely it is ground down;
adding breeze-type carbon to the clinker, together with the plaster stone and baked plaster;
continue grinding to obtain a fineness greater than 3,450 cm²/g, which should be monitored by the percentage of material passing through a number 100 or 200 sieve (free mesh span of 0.147 and 0.074 millimetres respectively);
it should be stored in silos for at least three days, but no more than six;

4. The method of manufacturing Portland cement with optical and electrical conduction properties in accordance with claim 1 or 2 where the glass powder consists of those present on the market, the composition of which contains a maximum magnesia content of 5%.

5. The method of manufacturing Portland cement with optical and electrical conduction properties in accordance with claim 1 or 2, in which the glass powder grain size is less than one millimetre in diameter.

6. The method of manufacturing Portland cement with optical and electrical conduction properties in accordance with claim 1 or 2, in which the amount of glass powder to be employed should be 5% of the total weight of plaster stone and baked plaster.

7. The method of manufacturing Portland cement with optical and electrical conduction properties in accordance with claim 1 or 2, in which the content of pieces of epoxy resin, is between 30% and 54% of the weight of clinker, with 46% being optimum.

8. The method of manufacturing Portland cement with optical and electrical conduction properties in accordance with claim 1 or 2, in which the pieces of epoxy resin are added when the clinker has already been cooled and does not have a temperature exceeding 75 degrees centigrade.

9. The method of manufacturing Portland cement with optical and electrical conduction properties in accordance with claim 1 or 2, in which the resin grain size used in this grinding should be at least 55% with a diameter greater than 20 millimetres and a maximum of 45% with a diameter less than 15 millimetres.

10. The method of manufacturing Portland cement with optical and electrical conduction properties in accordance with claim 1 or 3, in which the breeze-type coke content should be between 37% and 49% the weight of the clinker, with the optimum being 42.7%.

11. The method of manufacturing Portland cement with optical and electrical conduction properties in accordance with claim 1 or 3, in which the breeze-type coke is added when the clinker has already been cooled and does not have a temperature exceeding 55 degrees centigrade.

12. The method of manufacturing Portland cement with optical and electrical conduction properties in accordance with claim 1 or 2, in which the grain size for the coke use in this grinding operation should have at least 45% coke with a diameter exceeding 12 millimetres and 55% of the coke with a diameter of less than 7 millimetres.

13. The method of manufacturing Portland cement with optical and electrical conduction properties in accordance with claim 1 characterised in that the resulting cement has a fineness better than 3,450 cm²/g.

14. Portland cement obtained in accordance with the procedure claimed in clause 1 or 2 characterised in that it is translucent when set.

15. Portland cement in accordance with claim 14 characterised in that it presents a mechanical strength of 75 MPa and up to 250 MPa when its sets and without any additions.

16. Portland cement in accordance with claim 14 characterised in that it permits a reduction in the water required to obtain a determined tempering.

17. Portland cement in accordance with claim 14 characterised in that once it is hydrated it acquires 70% of its final strength within 48 hours.

18. Portland cement in accordance with claim 14 characterised in that maintains an opaque glass surface appearance.

19. Portland cement in accordance with claim 14 characterised in that it permits cathode protection of the reinforcement steel, together with any material found in the reinforced concrete.

20. Portland cement in accordance with claim 14 characterised in that maintains a useful service lifetime of up to 70 years under normal service conditions.

21. Portland cement in accordance with claim 14 characterised in that it is highly sulphate-resistant.

22. Portland cement obtained in accordance with the procedure claimed in clause 1 or 3 characterised in that it permits electrical conduction even before it sets.

23. Portland cement in accordance with claim 22 characterised in that it has a fineness exceeding 3,450 cm²/g.

24. Portland cement in accordance with claim 22 characterised in that it permits cathode protection of the reinforcement steel, together with any material found in the reinforced concrete.

25. Portland cement in accordance with claim 22 characterised in that maintains a useful service lifetime of up to 70 years under normal service conditions.

26. Portland cement in accordance with claim 22 characterised in that it is moderately sulphate-resistant.

27. Portland cement in accordance with claim 22 characterised in that it permits a reduction in the water required to obtain a determined tempering.

28. Portland cement in accordance with claim 22 characterised in that it presents a mechanical strength of 26 MPa and up to 65 MPa when its sets and without any additions.

29. Portland cement in accordance with claim 22 characterised in that once it is hydrated it acquires 60% of its final strength within 40 hours.
